(19) United States
(12) Patent Application Publication
(10) Pub. No.: US 2020/0090085 A1
(43) Pub. Date: Mar. 19, 2020

(54) DIGITAL TWIN GRAPH

(71) Applicant: Siemens Aktiengesellschaft, München (DE)

(72) Inventors: Arquimedes Martinez Canedo, Plainsboro, NJ (US); Livio Dalloro, Plainsboro, NJ (US)

(21) Appl. No.: 16/470,666

(22) PCT Filed: Jan. 16, 2017
(86) PCT No.: PCT/US2017/013647

§ 371 Date: Jun. 18, 2019

(51) Int. Cl. G06Q 10/06; G06F 16/901

(52) U.S. Cl. CPC G06Q 10/067; G06Q 10/0637; G06F 16/9024

(57) ABSTRACT

A system for managing a plurality of digital twins using a graph-based structure, the system includes one or more databases storing a digital twin graph comprising a plurality of subgraphs. Each sub-graph comprises a plurality of nodes associated with a distinct physical object. The system further includes one or more sensor interfaces that are configured to receive data corresponding to one or more remote physical objects. Additionally, the system includes a computing system which is configured to modify the plurality of sub-graphs and edge connections between the plurality of sub-graphs based on the data received via the one or more sensor interfaces.

### TECHNICAL FIELD

The present disclosure generally relates to systems, methods, and apparatuses for creating and utilizing a graph-based structure for managing digital twins. The techniques described herein may be applied, for example, to analyze relationships existing between real world, physical devices in various operational environments.

### BACKGROUND

A digital twin (DT) is a digital version of a machine. Once created, the DT can be used to represent the machine in a digital representation of a real world system. The DT is created such that it is identical in form and behavior of the corresponding machine. Additionally, the DT may mirror the status of the machine within a greater system. For example, sensors may be placed on the machine to capture real-time (or near real-time) data from the physical object to relay it back to a remote DT. The DT can then make any changes necessary to maintain its correspondence to the physical twin.

Conventional DT implementations are designed with a focus on object-level behaviors. A current focus of DT technology is to create a digital counterpart of an object that can be used to identify opportunities to increase an object's efficiency. For example, it has been demonstrated that a wind turbine's DT can be used to provide up to 20% more energy capacity than a wind turbine without a DT. This is achieved through the collection, visualization, and analysis of data from the wind turbine, and the use of predictive analytics to assist the operational strategy planning. This is an object-level spatial DT because it only captures the object during operation (a single phase does not capture the temporal aspects).

Other conventional systems employ a broader view, with an object-level spatio-temporal DT. This DT captures the object's characteristics from design, engineering, production, operation, service, maintenance, and end of life. To capture the spatio-temporal aspects, some systems use a monolithic representation approach that an object's digital representation aggregates all facets and data required from different lifecycle stages. This approach, referred to as the mechatronic object, is not efficient because the resulting object quickly gets bloated by the aggregation of all necessary data. Moreover, this DT does not capture the interaction flows between different DTs or the business flows that objects are subject to in the real world.

### SUMMARY

Embodiments of the present invention address and overcome one or more of the above shortcomings and drawbacks, by providing methods, systems, and apparatuses related to a graph-based structure for managing digital twins (DTs). This graph-based structure is referred to herein as a “digital twin graph” or “DTG.” The DTG technology described herein may be used, for example, to provide manufacturers with a detailed view of relationships between various real world physical devices and other entities (e.g. humans). Using the DTG paradigm, designers, manufacturers, and maintenance providers can interact with each other for better quality products and more effective maintenance results.

According to some embodiments, a system for managing a plurality of digital twins using a graph-based structure, the system includes one or more databases storing a DTG comprising a plurality of sub-graphs. Each sub-graph comprises a plurality of nodes associated with a distinct physical object. For example, in some embodiments, each node in the graph corresponds to a digital twin unit associated with the distinct physical object. The system further includes one or more sensor interfaces that are configured to receive data corresponding to one or more remote physical objects. Additionally, the system includes a computing system which is configured to modify the sub-graphs and edge connections between the sub-graphs based on the data received via the one or more sensor interfaces.

For example, assume that the DTG comprises a first sub-graph corresponding to a first physical object and a second-graph corresponding to a second physical object connected by an edge indicating that the first physical object is using the second physical object. The first and second physical objects may be, for example, a human and vehicle, respectively. If the computing system determines that the first physical object is no longer using the second physical object, the corresponding edge may be deleted from the DTG. Instead of (or in addition to), graph edges indicating present use, the edges may indicate past use of a second physical object by a first physical object. Based on this indication of past use, a time period corresponding to future use of the second physical object by the first physical object may be predicted. Moreover, updates (e.g., software upgrades) to the second physical object can be scheduled outside of the predicted time period. In some embodiments, the time period is predicted using simulation models which simulate behavior of the first physical object and the second physical object. In these embodiments, the computing system may include a simulation platform configured to execute each respective simulation model using simulation engines executing in parallel across a plurality of processors. In one embodiment, the sensor interfaces comprises a web service interface configured to facilitate communication with the remote physical objects. The system may also include a mobile device interface configured to facilitate (i) monitoring of the remote physical objects to determine the data corresponding to the remote physical objects and (ii) transferring of the data corresponding to the remote physical objects via the web service interface.

According to another aspect of the present invention, a computer-implemented method for using a graph-based structure to manage digital twins corresponding to physical objects includes a computing system generating a DTG comprising sub-graphs. Each sub-graph includes nodes associated with a distinct physical object. The computing system receives usage data indicating usage of one or more remote physical objects, for example, by monitoring activities of the remote physical objects. Then, the computing system modifies the sub-graphs and edge connections between the sub-graphs based on the usage data.

The aforementioned method may further include deletion of edges based on non-usage of particular objects. For example, in one embodiment, the DTG comprises a first sub-graph corresponding to a first physical object and a second-graph corresponding to a second physical object. The two sub-graphs are connected by an edge indicating that the first physical object is using the second physical object. The method may then further include determining that the first physical object is no longer using the second physical object and deleting the edge from the DTG.

The DTG in aforementioned method may additionally be used for prediction purposes. For example, in one embodiment, the DTG comprises a first sub-graph corresponding to a first physical object and a second-graph corresponding to a second physical object connected by an edge indicating that the first physical object has previously used the second physical object. The method may then further include predicting a time period corresponding to future use of the second physical object by the first physical object based on one or more digital twin unit included in the DTG. Additionally, the method may include scheduling, and possibly delivering, an update to the second physical object outside of the predicted time period corresponding to future use of the second physical object.

According to other embodiments of the present invention, a computer-implemented method for managing digital twins includes determining a relationship between a first physical object and a second physical object and identifying a first sub-graph corresponding to the first physical object in a DTG. This first sub-graph comprises first digital twin units associated with the first physical object. The method further includes identifying a second sub-graph corresponding to the second physical object in the DTG. The second sub-graph comprises second digital twin units associated with the second physical object. Based on the determined relationship, an edge in the DTG is created, updated, or deleted.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows how the DTG can be used as the information fabric where real-world objects and their relationships are represented digitally, according to some embodiments of the present invention;

FIG. 2 provides an example of the edges that may exist in the DTG, according to some embodiments;

FIG. 3 provides an example of morphing of the DTG over time, as may occur in some embodiments;

FIG. 4 illustrates a system implementing a three-layer DTG architecture, as utilized in some embodiments of the present invention;

FIG. 5 provides a more detailed illustration of the three-layer DTG architecture shown in FIG. 4, as it may be implemented in some embodiments; and

FIG. 6 provides an example of a parallel processing memory architecture that may be utilized to perform computations related to execution of the various workflows discussed herein, according to some embodiments of the present invention.

### DETAILED DESCRIPTION

The following disclosure describes the present invention according to several embodiments directed at methods, systems, and apparatuses related to a graph representation of digital twin entities. Rather than relying in a monolithic data structure, the techniques described herein focus on the relationships between DTs. As described in further detail below, in various embodiments described herein, each object's DT is represented by sub-graphs (i.e., collections of nodes) embedded in the DTG. Each node is referred to as a Digital Twin Unit (DTU). The DTG described herein is readily queryable; information retrieval is done efficiently using graph search and content filtering. The DTG is also traceable because every single update to the graph may be tracked and, thus, any past state can be recreated. Moreover the DTG is extensible, supporting as many types of nodes, their content, and their relationships as necessary.

The DTG is dynamic in the sense that the graph can continuously morph with the creation and elimination of nodes and edges. This morphing is the result of updates by data, queries, simulation, models, new providers, new consumers, and dynamic relationships between them. Even though the DTG may comprise a large graph with billions of nodes and edges, existing databases (e.g., GraphX, Linked Data) and algorithms (e.g., Pregel, MapReduce) running in cloud platforms will help to efficiently search and update the DTG. Alternatively, a specialized database that uses graph structures for semantic queries (i.e., a “graph database”) may be used in some embodiments. The DTG representation is also suitable for a smooth integration with novel mathematical engines based on graph-theoretic and categorical approaches. Thus, in some embodiments, the DTG is also self-learning in the sense that algorithms may be used to analyze the morphing of the graph to identify emergent patterns and behaviors.

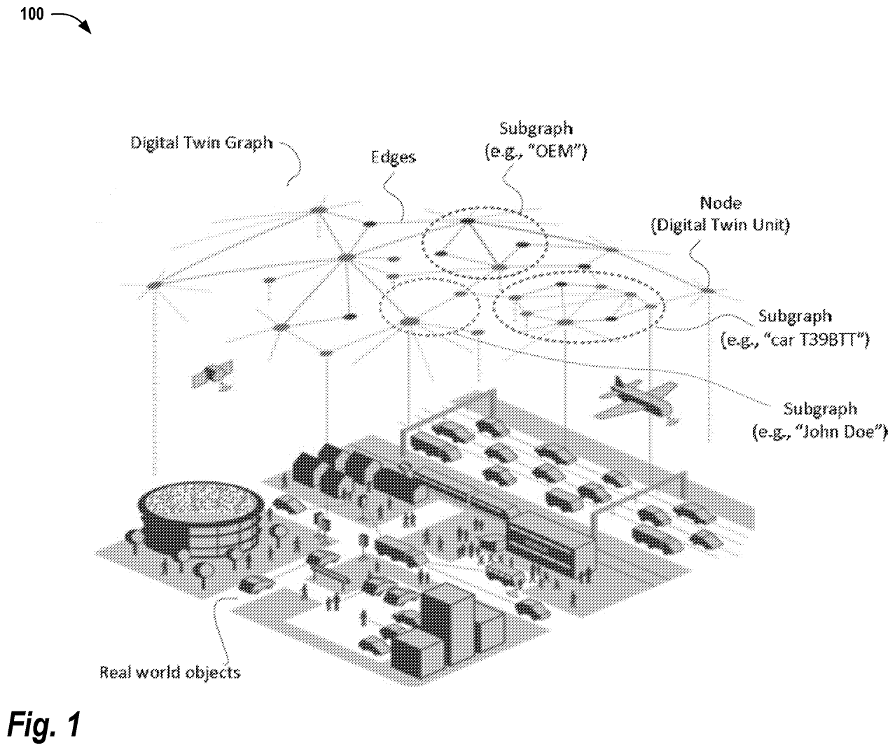

FIG. 1 shows how the DTG can be used as the information fabric where real-world objects and their relationships are represented digitally, according to some embodiments of the present invention. Real world physical objects such as cars, people, buildings, airplanes, highways, houses, transportation systems are represented in the DTG. A real-world object is not represented by a single node, but by a sub-graph in the DTG. For example, a car “T39BTT” is represented by multiple DTUs in a sub-graph. The DTUs in the sub-graph may represent, for example, the CAD design, the service records, its current state (where it is, its speed, etc.), its manufacturing information (where it was produced, by which machines, etc.). Similarly, another sub-graph represents a person, “John Doe”, and its DTUs hold his identity, health records, agenda, etc. Notice that there is an edge connecting “John Doe” to the car “T39BTT”, and this may represent, for example, that “John Doe is currently driving the T39BTT car”. As soon as John arrives to his destination and turns off his car, this “driving” edge may be removed from the DTG. Note that, although the DTG changes, all transactions are being recorded by the underlying DTG for further analysis. With the historical information between “John Doe” and his “T39BTT” car, we can, for example, predict when John Doe will wake up the next morning to drive his car to work and the original equipment manufacturer (OEM) of the car can use this information to push a software update to the car through the air while John Doe sleeps. This update by the OEM, also updates the DTG. Interactions like these are continuously updating the DTG.

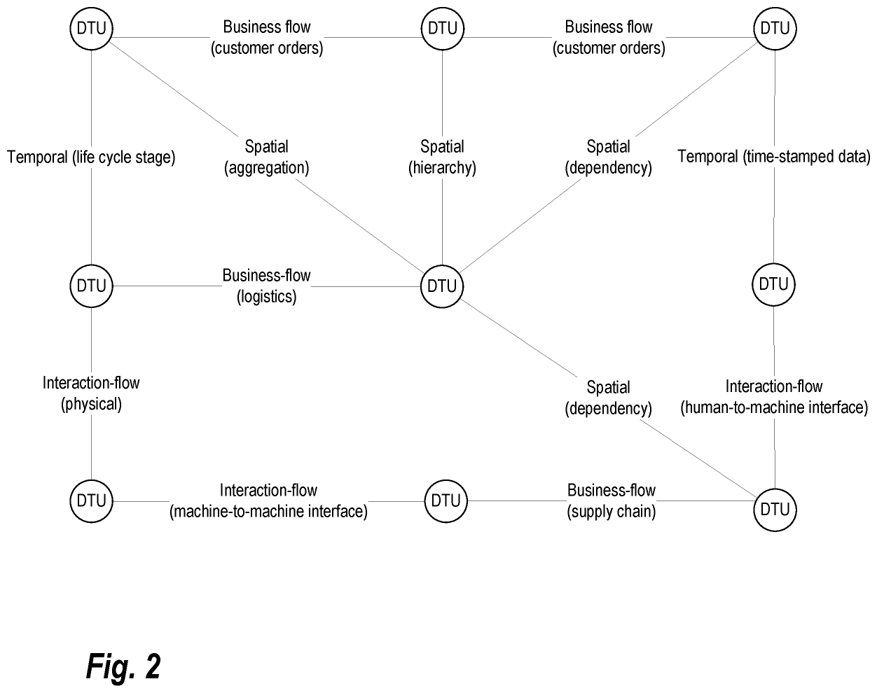

FIG. 2 provides an example of the edges that may exist in the DTG, according to some embodiments. Edges connecting nodes are used to represent the relationships between the DTUs. Edges can be, for example, spatial (e.g., aggregations, hierarchies, dependencies), temporal (e.g., life cycle stages, time-stamped data), interaction flow-related (e.g., physical, information, and non-physical interfaces including machine-machine, machine-human, human-machine), and/or business flow-related (e.g., supply chain, customer orders, logistics, financials, organizational, etc.). This representation gives the DTG the flexibility to use the DTs associated with the different nodes “as-is” (e.g., for parsing, evaluation, simulation), and the information associated to the edges to discover and create new knowledge through graph and data analysis algorithms. The flows of interaction give the DTG the ability to express spatio-temporal representations between the producers and consumers of the DT.

To bootstrap the DTG, a mixed-driven approach may be used that incorporates scenario information, engineering knowledge, and general knowledge. Each scenario defines the most useful abstractions and interfaces. These scenarios are used to populate the DTG. Engineering knowledge is then incorporated including, for example, engineering principles (books, manuals, patents), models, time series data, system telemetry, and command and control “at work” information. The data source engineering knowledge is processed by one or more extractors to extract relevant information for the DTG. Similarly existing general knowledge bases, ontonlogies, and tools are processed to extract data and incorporate it into the DTG via new DTUs or edge connections.

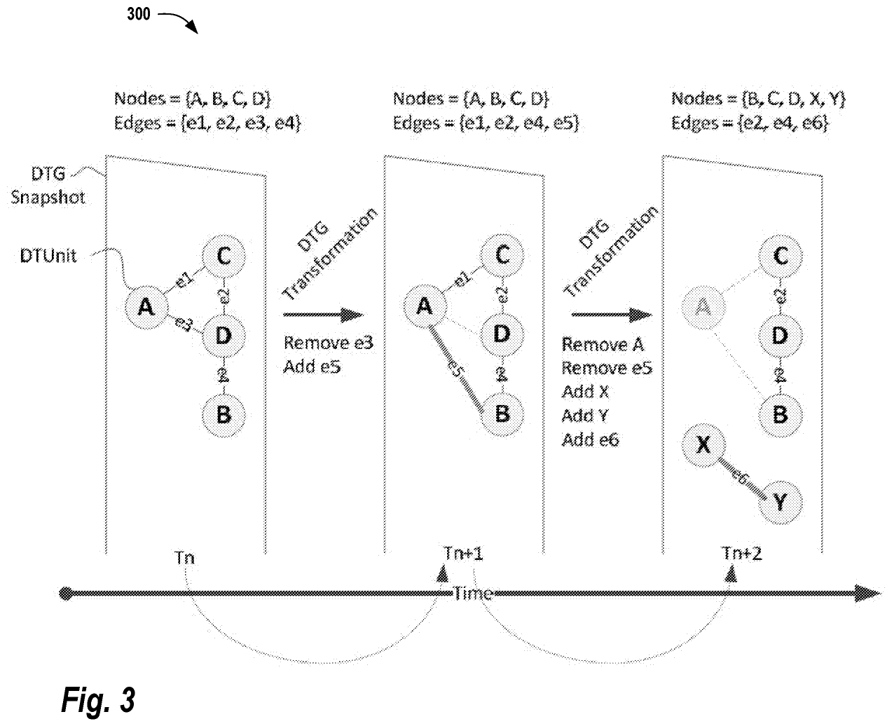

The DTG has the ability to constantly change. The morphing of the DTG over time can be visualized with the “DTG Snapshots” shown in FIG. 3. The first snapshot taken at time Tn comprises four nodes ({A,B,C,D}) and four edges ({e1, e2, e3, e4}). The transition between Tn and Tn+1 snapshots is referred to herein as a “DTG Transformation” where the graph structure is modified by operations. In this case, the “remove e3” and the “add e5” edges. Thus, the resulting Tn+1 snapshot consists of four nodes ({A,B,C,D}) and four edges ({e1, e2, e4, e5}). The second transition from Tn+1 to Tn+2 comprises “remove A”, “remove e5”, “add X”, “add Y”, and “add e6” operations. The resulting graph at Tn+2 includes five nodes ({B,C,D,X,Y)} and three edges ({e2, e4, e6}). Note that nodes represent DTUs, and edges represent relationships between DTUs. In practice, it has been demonstrated that a graph architecture can scale to billions of changes per day. Thus, the DTG provides a flexible computational and data fabric for the DT.

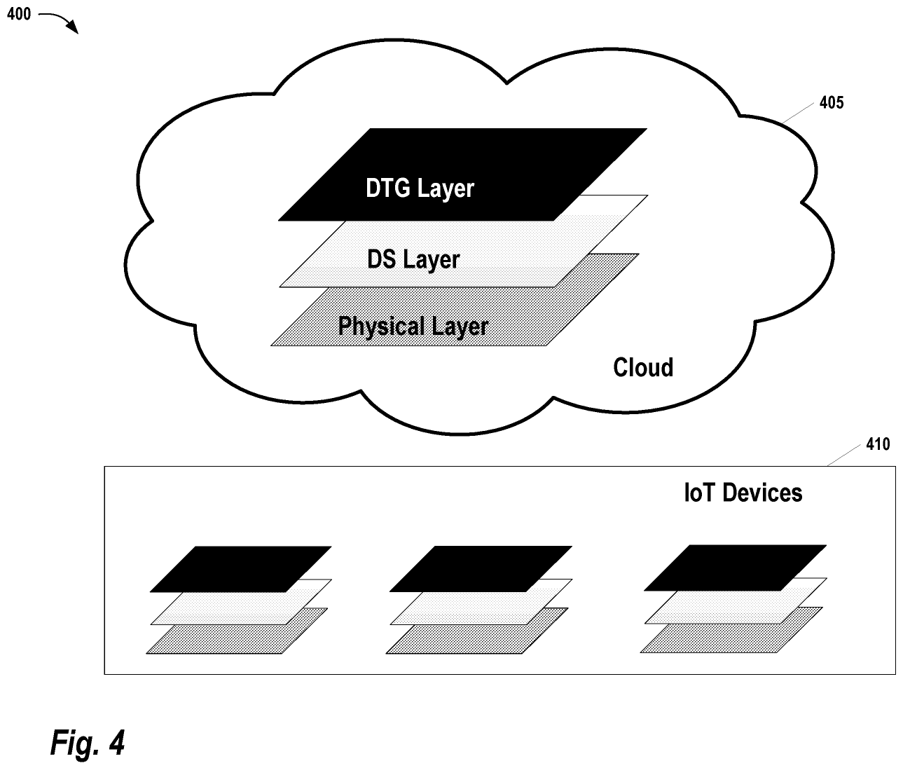

FIG. 4 illustrates a system 400 implementing a three-layer DTG architecture, as utilized in some embodiments of the present invention. This system 400 is conceptually partitioned into device operating within Cloud 405 and Internet of Things (IoT) Devices 410. Here, Cloud 405 includes the DTG software residing within a computer data center. The IoT Devices 410 may comprise, for example, single chip computers, smart phones, mobile devices, sensors, etc., capable of communicating with remote computers via the Hypertext Transfer Protocol (HTTP) protocols. The three-layer DTG architecture implemented at Cloud 405 and Internet of Things (IoT) Devices 410 comprises a DTG layer, a data and simulation (DS) layer, and a physical layer which represents the computation equipment utilized.

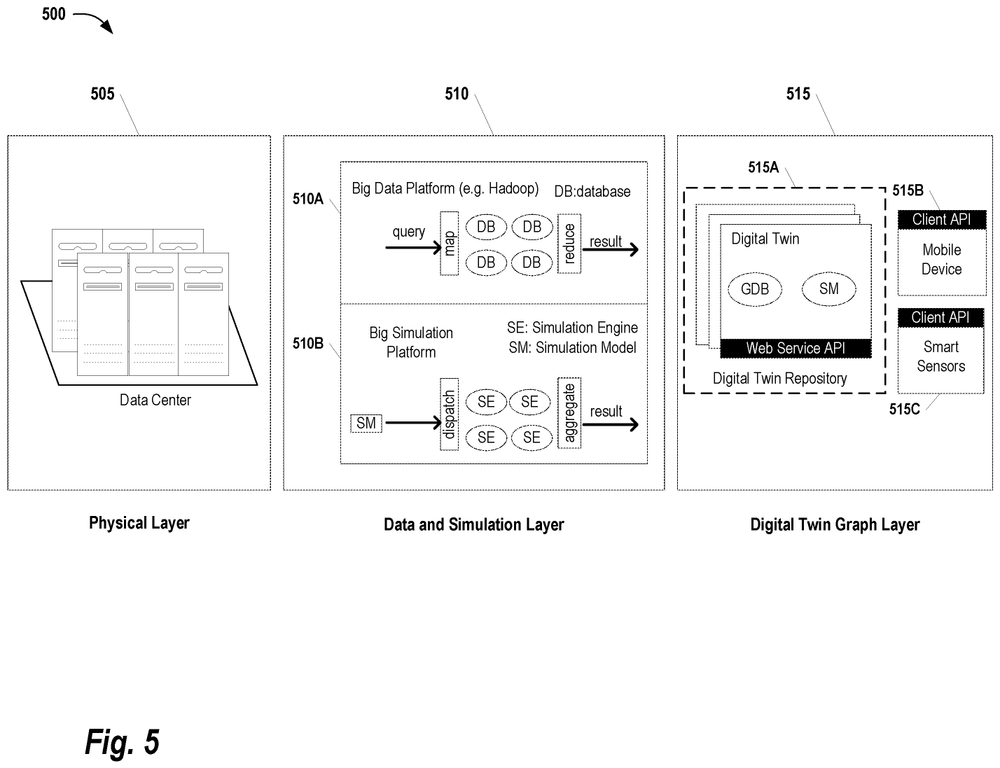

FIG. 5 provides a more detailed illustration 500 of the three-layer DTG architecture shown in FIG. 5, as it may be implemented in some embodiments. The Physical layer 505 comprises a large number of computers and supporting equipment within a data center. The Big Data Platform 510A within the DS Layer refers to a parallel, distributed, and large scale NoSQL database infrastructure supported by the computers in the Physical Layer 505. In some embodiments, a customized database infrastructure may be developed specifically configured to DTG-related demands. In other embodiments, a big data database infrastructure such as Hadoop or Bigtable may be employed.

In the example of FIG. 5, the Big Data Platform 510A provides “map-reduce” functionality, where the data query tasks are automatically dispatched to the proper computers within the data center at the physical layer 505. Additionally, query results may be automatically aggregated. The Big Simulation Platform 510B included at the DS Layer 510 provides a structure which is similar to that employed by the Big Data Platform 510A, except that simulation tasks are automatically dispatched to simulation engines and the results are automatically aggregated. It should be noted that the aforementioned “model based” Bayesian filtering (also known as Bayesian inference), approach is considered as one class of simulation tasks. In some embodiments, the simulation models are executed continuously. Thus, as new data becomes available, the DTG can continuously morph with the creation and elimination of nodes and edges.

At the DTG Layer 515, a DT Repository (DTR) 515A hosts and manages numerous DTs. Each DT is associated with one and only one machine. The DT is comparable to the observer, in the sense any updates in the associated physical machine are recorded in the corresponding DT as well. In the example of FIG. 5, each DT comprise a graph database (GDB) which stores the sub-graph corresponding to a physical machine, structure, or other entity represented in the DTG. As is commonly understood in the art, a graph database is a database management system which performs Create, Read, Update and Delete (CRUD) operations on a graph data model. Examples of graph databases that may be utilized include, without limitation, Neo-4j, HyperGraphDB, DEX, InfoGrid, Sones, and VertexDB. The GDB of each DT are further linked such that they collectively amount to the DTG of the entire system. As an alternative to having multiple GDBs, in some embodiments, a single GDB is used and the designation of each sub-graph (i.e., each DT) may be explicitly stored along with information describing the various nodes and edges comprising the DTG. In other embodiments, a SQL or no-SQL database that is not graph-based may be used and custom routines (e.g., implemented in MapReduce in the Data and Simulation Layer 510) may be used to support graph traversal operations. To support portability and human readability of DT information, the subnetwork of each DT may be stored using a graph-based file format such as GXL (Graph eXchange Language) or GraphML.

In the example of FIG. 5, each DT also includes a simulation model (SM). The SM may be provided, for example, by an Original Equipment Manufacturer (OEM) or control engineer. Additionally, although only one SM is shown in FIG. 5, it should be understood that a DT may have multiple SMs associated with it. The exact implementation of each SM will vary, depending the specific characteristics of the DT. In some embodiments, the SMs are dynamic in nature in the sense that they can use data from varying numbers of DTUs as input. Thus, as more data becomes available, the model can further refined. Moreover, this modeling flexibility allows the specificity of the model to evolve over time. In some embodiments, each DT starts with a generic modeling component. As data from DTUs in the DT's sub-graph are received, different, more specific models may replace the generic one. For example, a generic model for a DTG may be replaced with a vehicle model once information is received indicating the DT represents a vehicle entity. Then, once further information is received on the make and model of the vehicle, the vehicle model can be replaced with a model that is specific to the features and characteristics of the particular vehicle being modeled.

The DTG Layer 515 also includes two application program interfaces (API) for interfacing with the DT Repository 515A. A Mobile Device Client API 515B provides an interface for communicating with mobile devices such as computers, smart phones, and tablet devices. In some embodiments, the Mobile Device Client API 515B provides a web-based interface such that mobile devices can communicate with the DTR 515A using a web service. In other embodiments, the Mobile Device Client API 515B may provide a more specialized interface that offers features specific to a type of mobile device. The Smart Sensor Client API 515C provides an interface for sensors co-located with the physical entities in the DTG being monitored (e.g., on, in, or near the machines). As with the Mobile Device Client API 515B, the Smart Sensor Client API 515C may be implemented using a generic interface (e.g., a simple web-based messaging system) or a more specialized interface may be customized to meet the monitoring demands of the DTR. For example, the Smart Sensor Client API 515C may be implemented to support a messaging protocol such as the User Datagram Protocol (UDP), Transmission Control Protocol (TCP), or HTTP.

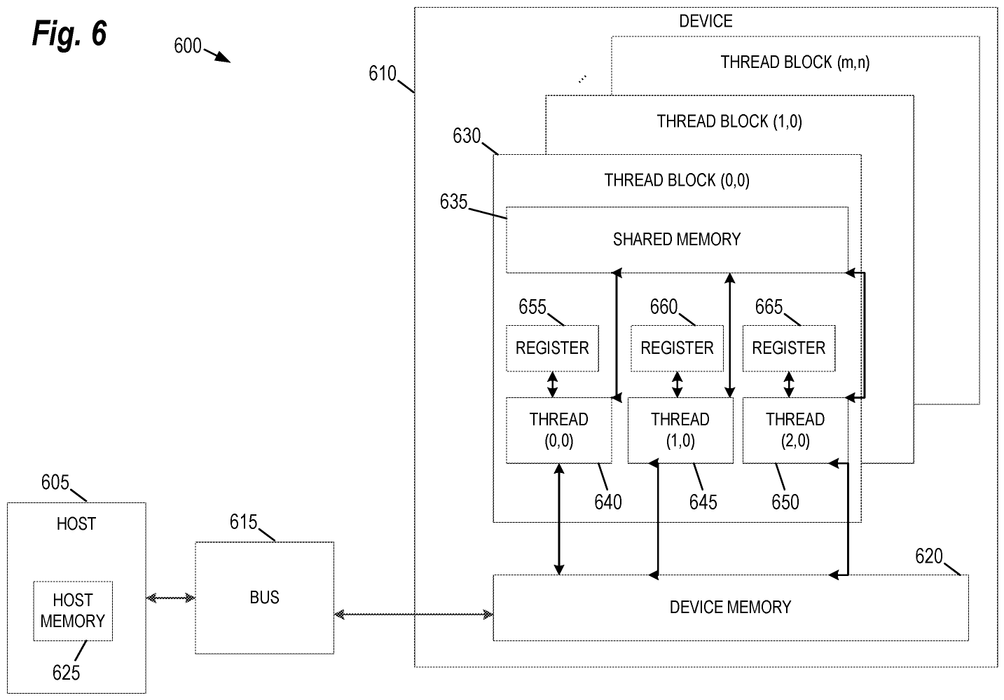

FIG. 6 provides an example of a parallel processing memory architecture 600 that may be utilized to perform computations related to execution of the various workflows discussed herein, according to some embodiments of the present invention. This architecture 600 may be used in embodiments of the present invention where NVIDIA™ CUDA (or a similar parallel computing platform) is used. The architecture includes a host computing unit (“host”) 605 and a graphics processing unit (GPU) device (“device”) 610 connected via a bus 615 (e.g., a PCIe bus). The host 605 includes the central processing unit, or “CPU” (not shown in FIG. 6), and host memory 625 accessible to the CPU. The device 610 includes the graphics processing unit (GPU) and its associated memory 620, referred to herein as device memory. The device memory 620 may include various types of memory, each optimized for different memory usages. For example, in some embodiments, the device memory includes global memory, constant memory, and texture memory.

Parallel portions of a big data platform and/or big simulation platform (see FIG. 5) may be executed on the architecture 600 as “device kernels” or simply “kernels.” A kernel comprises parameterized code configured to perform a particular function. The parallel computing platform is configured to execute these kernels in an optimal manner across the architecture 600 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the architecture 600 of FIG. 6 (or similar architectures) may be used to parallelize modification or analysis of the digital twin graph. For example, in some embodiments, the operations of the big data platform may be partitioned such that multiple kernels analyze different sub-graphs or relationships between DTUs simultaneously.

The device 610 includes one or more thread blocks 630 which represent the computation unit of the device 610. The term thread block refers to a group of threads that can cooperate via shared memory and synchronize their execution to coordinate memory accesses. For example, in FIG. 6, threads 640, 645 and 650 operate in thread block 630 and access shared memory 635. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 6, the thread blocks 630 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints.

Continuing with reference to FIG. 6, registers 655, 660, and 665 represent the fast memory available to thread block 630. Each register is only accessible by a single thread. Thus, for example, register 655 may only be accessed by thread 640. Conversely, shared memory is allocated per thread block, so all threads in the block have access to the same shared memory. Thus, shared memory 635 is designed to be accessed, in parallel, by each thread 640, 645, and 650 in thread block 630. Threads can access data in shared memory 635 loaded from device memory 620 by other threads within the same thread block (e.g., thread block 630). The device memory 620 is accessed by all blocks of the grid and may be implemented using, for example, Dynamic Random-Access Memory (DRAM).

Each thread can have one or more levels of memory access. For example, in the architecture 600 of FIG. 6, each thread may have three levels of memory access. First, each thread 640, 645, 650, can read and write to its corresponding registers 655, 660, and 665. Registers provide the fastest memory access to threads because there are no synchronization issues and the register is generally located close to a multiprocessor executing the thread. Second, each thread 640, 645, 650 in thread block 630, may read and write data to the shared memory 635 corresponding to that block 630. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 610 to read and/or write to the device memory. Device memory requires the longest time to access because access must be synchronized across the thread blocks operating on the device. Thus, in some embodiments, the processing of each sub-graph is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 6, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A system for managing a plurality of digital twins using a graph-based structure, the system comprising:
one or more databases storing a digital twin graph comprising a plurality of sub-graphs, wherein each sub-graph comprises a plurality of nodes associated with a distinct physical object; and
one or more sensor interfaces configured to receive data corresponding to one or more remote physical objects; and
a computing system configured to modify the plurality of sub-graphs and edge connections between the plurality of sub-graphs based on the data received via the one or more sensor interfaces.

2. The system of claim 1, wherein each of the plurality of nodes corresponds to a digital twin unit associated with the distinct physical object.

3. The system of claim 1, wherein the digital twin graph comprises a first sub-graph corresponding to a first physical object and a second-graph corresponding to a second physical object connected by an edge indicating that the first physical object is using the second physical object.

4. The system of claim 3, wherein the first physical object is a human.

5. The system of claim 4, wherein the second physical object is a vehicle.

6. The system of claim 3, wherein the computing system is further configured to:
determining that the first physical object is no longer using the second physical object; and
deleting the edge from the digital twin graph.

7. The system of claim 1, wherein the digital twin graph comprises a first sub-graph corresponding to a first physical object and a second-graph corresponding to a second physical object connected by an edge indicating that the first physical object has previously used the second physical object.

8. The system of claim 7, wherein the computing system is further configured to:
predicting a time period corresponding to future use of the second physical object by the first physical object based on one or more digital twin unit included in the digital twin graph.

9. The system of claim 8, wherein the computing system is further configured to:
scheduling an update to the second physical object outside of the predicted time period corresponding to future use of the second physical object.

10. The system of claim 8, wherein the computing system is further configured to predict the time period using a plurality of simulation models simulating behavior of the first physical object and the second physical object.

11. The system of claim 10, wherein the computing system comprises a simulation platform configured to execute each respective simulation model using a plurality of simulation engines executing in parallel across a plurality of processors.

12. The system of claim 1, wherein the one or more sensor interfaces comprises a web service interface configured to facilitate communication with the one or more remote physical objects.

13. The system of claim 12, wherein the system further comprises a mobile device interface configured to facilitate (i) monitoring of the one or more remote physical objects to determine the data corresponding to the one or more remote physical objects and (ii) transferring of the data corresponding to the one or more remote physical objects via the web service interface.

14. A computer-implemented method for using a graph-based structure to manage digital twins corresponding to a plurality of physical objects, the method comprising:
generating, by a computing system, a digital twin graph comprising a plurality of sub-graphs, wherein each sub-graph comprises a plurality of nodes associated with a distinct physical object; and
receiving, by the computing system, usage data indicating usage of one or more remote physical objects; and
modifying, by the computing system, the plurality of sub-graphs and edge connections between the plurality of sub-graphs based on the usage data.

15. The method of claim 14, wherein the digital twin graph comprises a first sub-graph corresponding to a first physical object and a second-graph corresponding to a second physical object connected by an edge indicating that the first physical object is using the second physical object, and the method further comprises:
determining that the first physical object is no longer using the second physical object; and
deleting the edge from the digital twin graph.

16. The method of claim 14, wherein the digital twin graph comprises a first sub-graph corresponding to a first physical object and a second-graph corresponding to a second physical object connected by an edge indicating that the first physical object has previously used the second physical object, and the method further comprises:
predicting a time period corresponding to future use of the second physical object by the first physical object based on one or more digital twin unit included in the digital twin graph.

17. The method of claim 16, wherein the method further comprises:
scheduling an update to the second physical object outside of the predicted time period corresponding to future use of the second physical object.

18. The method of claim 17, further comprising:
delivering the update to the second physical object at a scheduled time.

19. The method of claim 14, wherein receiving the usage data indicating usage of one or more remote physical objects comprises:
monitoring activities of the one or more remote physical objects to determine the usage data.

20. A computer-implemented method for managing a plurality of digital twins, the method comprising:
determining a relationship between a first physical object and a second physical object;
identifying a first sub-graph corresponding to the first physical object in a digital twin graph, wherein the first sub-graph comprises first digital twin units associated with the first physical object;
identifying a second sub-graph corresponding to the second physical object in the digital twin graph, wherein the second sub-graph comprises second digital twin units associated with the second physical object; and
creating, updating, or deleting an edge in the digital twin graph between the first sub-graph and the second sub-graph based on the relationship.
